(19) United States
(12) Patent Application Publication
(10) Pub. No.: US 2022/0137796 A1
(43) Pub. Date: May 5, 2022

(54) SCREEN ADAPTATION AND DISPLAYING METHOD, ELECTRONIC DEVICE AND COMPUTER STORAGE MEDIUM

(71) Applicant: ZHANGYUE TECHNOLOGY CO., LTD., Beijing (CN)

(72) Inventor: Yalei WANG, Beijing (CN)

(21) Appl. No.: 17/427,465

(22) PCT Filed: Nov. 18, 2019
(86) PCT No.: PCT/CN2019/119262

§ 371 Date: Jul. 30, 2021

(30) Foreign Application Priority Data
Jan. 31, 2019 (CN) 201910100326.4

(51) Int. Cl. G06F 3/04845; G06F 3/0483; G06F 9/451

(52) U.S. Cl. CPC G06F 3/04845; G06F 9/451; G06F 3/0483

(57) ABSTRACT

The present disclosure disclose a screen adaptation and displaying method, an electronic device and a computer storage medium, for adjusting a page layout to adapt to a screen display. The method comprises: acquiring a predetermined layout template corresponding to a page to be displayed on a current screen; detecting whether a ratio of length to width of the current screen is consistent with a standard ratio of length to width of the predetermined layout template; and when the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

### CROSS REFERENCE TO RELATED APPLICATIONS

This application claims priority to Chinese Patent Application No. 2019101003264, titled “Screen Adaptation and Displaying Method, Electronic Device and Computer Storage Medium”, filed on Jan. 31, 2019 with the China Patent Office, the entire contents of which are incorporated herein by reference.

### TECHNICAL FIELD

Embodiments of the present disclosure relate to the field of computer technology, and in particular to a screen adaptation and displaying method, an electronic device and a computer storage medium.

### BACKGROUND

With the rapid development of smart devices cooperated with computer technology, smart devices based on different screen specifications are becoming more and more popular among the general public.

At present, smart devices with different screen specifications have different share in the existing market. Correspondingly, various kinds of software such as e-books, etc., usually will design user interfaces based on smart devices with mainstream screen specifications, and obtain a page layout template corresponding to mainstream screen specifications, so that that page layout template is used as the standard for displaying on various kinds of smart devices.

Among them, smart devices with mainstream screen specifications can obtain screen-adapted displaying based on the corresponding page layout template. However, smart devices with other screen specifications cannot perform adaptation and displaying in dependence on the page layout template corresponding to mainstream screen specifications, thereby affecting effective displaying of page information, and reducing aesthetics of page displaying and user experiences of users to which smart devices with different screen specifications belong.

### SUMMARY

In view of the above described problems, embodiments of the present disclosure are proposed to provide a screen adaptation and displaying method, an electronic device and a computer storage medium that overcome the above problems or at least partially solve the above problems.

According to one aspect of the present disclosure, a screen adaptation and displaying method is provided, for adjusting a page layout to adapt to screen display, wherein the method includes: acquiring a predetermined layout template corresponding to a page to be displayed on a current screen; detecting whether a ratio of length to width of the current screen is consistent with a standard ratio of length to width of the predetermined layout template; and when the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

According to another aspect of the present disclosure, an electronic device is provided, which includes: a processor, a memory, a communication interface, and a communication bus, through which the processor, the memory and the communication interface communicate with each other; wherein the memory is configured to store at least one executable instruction, which causes the processor to perform the following operations: acquiring a predetermined layout template corresponding to a page to be displayed on a current screen; detecting whether a ratio of length to width of the current screen is consistent with a standard ratio of length to width of the predetermined layout template; and when the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

According to further another aspect of the present disclosure, a non-volatile computer-readable storage medium is provided, in which at least one executable instruction is stored, wherein the executable instruction causes a processor to perform the following operations: acquiring a predetermined layout template corresponding to a page to be displayed on a current screen; detecting whether a ratio of length to width of the current screen is consistent with a standard ratio of length to width of the predetermined layout template; and when the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

According to yet another aspect of the present disclosure, a computer program product is further provided, which includes a calculation program stored on the above described non-volatile computer-readable storage medium.

In the screen adaptation and displaying method, the electronic device and the computer storage medium according to the present disclosure, before page displaying is performed, a preset page layout template of the page to be displayed is acquired, and by comparing a ratio of the length to width of a current screen with a standard ratio of length to width associated with and adapted to the preset layout template, when it is determined to be inconsistent, the page layout of the page to be displayed will be adjusted based on the ratio of length to width of the current screen, the standard ratio of length to width associated with and adapted to the preset layout template and the number of interface elements included in the preset layout template, so as to adapt to the current screen for displaying. By using the screen adaptation and displaying method of the present embodiment, adaptation and displaying of the page to be displayed on the current screen can be realized through the adjustment of the page layout in case that the page layout template is not adapted to the current screen, which avoids that lots of blanks and being not able to completely display appear in the page, so that effectiveness of page information display, aesthetics of page display, and user experiences of users to which smart devices with different screen specifications belong are improved.

The above description is only an overview of the technical solutions of the embodiments of the present disclosure. In order to enable clearer understanding and implementation of the technical means of the embodiments of the present disclosure in accordance with the contents of the specification, and for the purpose of enabling the above and other objects, features, and advantages of the embodiments of the present disclosure more obvious and easier to understand, specific implementation manners of the embodiments of the present disclosure will specifically exemplified below.

### BRIEF DESCRIPTION OF THE DRAWINGS

By reading the detailed description of the preferred embodiments below, various other advantages and benefits will become clear to those of ordinary skill in the art. The drawings are only used for the purpose of illustrating the preferred embodiments, and are not to be considered as limitation to the present disclosure. Also, throughout the drawings, the same reference symbols are used to denote the same components. In the drawings:

FIG. 1 shows a flowchart of a screen adaptation and displaying method provided by Embodiment 1 of the present disclosure;

FIG. 2 shows an example diagram of page layout adjustment provided by the Embodiment 1 of the present disclosure;

FIG. 3 shows a flowchart of a screen adaptation and displaying method provided by Embodiment 2 of the present disclosure;

FIG. 4 shows another example diagram of page layout adjustment provided by the Embodiment 2 of the present disclosure;

FIG. 5 shows another example diagram of page layout adjustment provided by the Embodiment 2 of the present disclosure;

FIG. 6 shows another example diagram of page layout adjustment provided by the Embodiment 2 of the present disclosure;

FIG. 7 shows another example diagram of page layout adjustment provided by the Embodiment 2 of the present disclosure;

FIG. 8 shows a flowchart of a screen adaptation and displaying method provided by Embodiment 3 of the present disclosure;

FIG. 9 shows a schematic structural diagram of an electronic device provided by Embodiment 5 of the present disclosure.

### DETAILED DESCRIPTION

Hereinafter, exemplary embodiments of the present disclosure will be described in more detail with reference to the accompanying drawings. Although the drawings show exemplary embodiments of the present disclosure, it should be understood that the present disclosure can be implemented in various forms and should not be limited by the embodiments set forth herein. On the contrary, these embodiments are provided to enable a more thorough understanding of the present disclosure and to fully convey the scope of the present disclosure to those skilled in the art.

### Embodiment 1

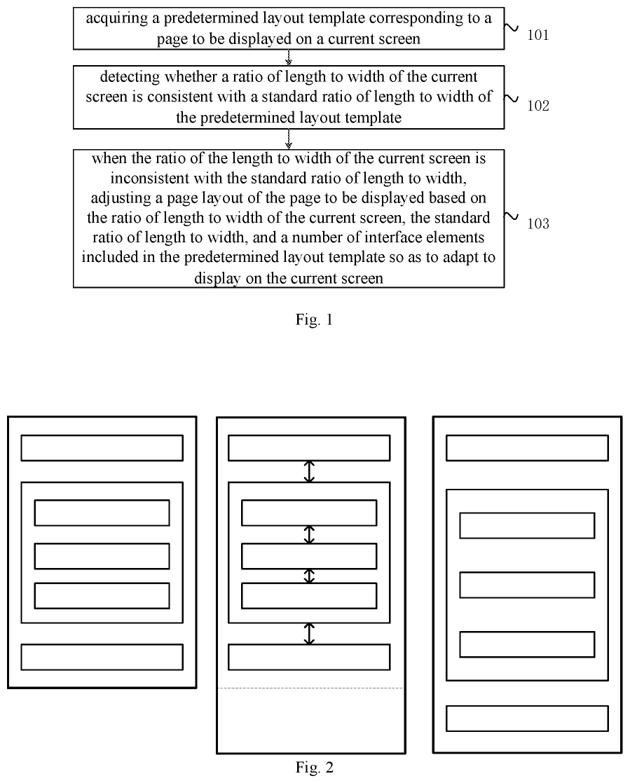

FIG. 1 shows a flowchart of a screen adaptation and displaying method provided by Embodiment 1 of the present disclosure, for adjusting a page layout to adapt to a screen display. As shown in FIG. 1, the method includes the following steps.

Step S101, acquiring a predetermined layout template corresponding to a page to be displayed on a current screen

In an embodiment of the present disclosure, the current screen refers to a screen on which the electronic device held by the user performs a page display. Through a system interface to the electronic device, attribute information of the current screen can be obtained. The attribute information of the current screen may include resolution of the current screen and information about a ratio of length to width such as screen ratio.

In the present embodiment, the page to be displayed refers to a page that is currently about to be displayed on the screen of the electronic device, but has not yet been displayed. The page to be displayed may be any display page associated with an application program, in which various forms of interface elements may be included. Correspondingly, the preset layout template refers to a page layout template pre-designed by a back-end developer of the application program. The preset layout template is based on a pre-specified screen resolution, such as current mainstream resolution. In the preset layout template, a layout design such as specific contents displayed by the each interface element in the page, display positions of the interface elements and intervals between the interface elements is pre-designed, so that the electronic device can perform displaying of an associated page in accordance with the page layout specified in the preset layout template by calling the preset layout template.

Specifically, when the current screen is about to display the page to be displayed, the electronic device may acquire the preset layout template of the page to be displayed from the server side. Alternatively, the preset layout template may be pre-stored in the local storage of the electronic device when the application is installed, so that the electronic device can acquire the preset layout template of the page to be displayed from the local storage.

Step S102, detecting whether a ratio of length to width of the current screen is consistent with a standard ratio of length to width of the predetermined layout template

In an embodiment of the present disclosure, the ratio of length to width refers to the ratio between the height and width of the screen, which can also be referred to as the aspect ratio or the screen ratio, and is usually represented by the ratio between the longer length and the shorter length of the screen, and can be calculated and obtained according to the physical resolution of the screen. A long screen refers to a screen whose longitudinal length significantly exceeds the horizontal length, and a wide screen refers to a screen whose horizontal length significantly exceeds the longitudinal length. When different screens have the same aspect ratio, their resolution may not be the same. For example, according to the screen adopted by the existing electronic device, the aspect ratio of the screen may include 16:9 or 19:9, etc. Correspondingly, the screen resolution may be 1080×1920 or 1080×2280, but it is not limited to this. Wherein as to the resolution of 1080×1920, it means that the number of pixels included in the horizontal direction of the screen is 1080, and the number of pixels included in the vertical direction is 1920.

In the present embodiment, by taking normal displaying of the screen or picture as a reference, the ratio of the longitudinal length to the horizontal length is determined to indicate the aspect ratio. Correspondingly, the ratio of length to width of the current screen refers to the ratio of the vertical length to the horizontal length of the screen when the current screen is normally displayed, such as a vertical screen or a horizontal screen. Since the preset layout template is adapted to the specified screen aspect ratio or screen resolution, such as the current mainstream screens, the ratio of length to width of a screen to which the preset layout template is adapted is referred to as the standard ratio of length to width, and the screen resolution to which the preset layout template is adapted is referred to as the standard resolution.

Specifically, as to the current screen of the current electronic device, the screen information of the current screen may be acquired through the system interface, and the ratio of length to width of the current screen may be acquired, or the ratio of length to width of the current screen may be determined according to the resolution of the current screen and the screen display direction. For the preset layout template, the standard ratio of length to width to which the preset layout template is adapted may be acquired, or the standard ratio of length to width may be determined according to the screen resolution to which the preset layout template is adapted. And the ratio of the length to width of the current screen is compared with the standard ratio of length to width to determine whether the ratio of the length to width of the current screen is consistent with the standard ratio of length to width.

If the ratio of the length to width of the current screen is inconsistent with the standard ratio of length to width, the preset layout template can be adjusted by the following adjustment manner for the page layout to adapt to displaying of the page to be displayed on the current screen. If the ratio of the length to width of the current screen is consistent with the standard ratio of length to width, it can be further determined whether the resolution of the current screen is consistent with the standard resolution. If the resolution of the current screen is inconsistent with the standard resolution, the preset layout template can be adjusted by an adjustment manner for the whole layout of the page to adapt to displaying of the page to be displayed on the current screen; if the resolution of the current screen is consistent with the standard resolution, displaying of the page to be displayed can be directly performed.

Step S103 when the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen

In an embodiment of the present disclosure, without distinguishing the ratio of the length to width or resolution of the current screen, if page displaying is performed by the current screen directly according to the preset page layout template, there may be a case, in which the preset page layout template is not adapted to the current screen, which in turn leads to phenomena of a blank or incomplete display in the current screen. Therefore, if a ratio of length to width of the current screen is inconsistent with a standard ratio of length to width, it is necessary to adjust layout details in the preset page layout template, such as to adjust interval distances between the interface elements, and to adjust the size of the each interface element and the displayed contents thereof, etc., to adapt to display on the current screen, so that the page displaying is more harmonious.

Interface elements refer to a series of elements which meet user interaction requirements included in software or system interfaces that can meet interaction requirements, such as interface elements such as windows, dialog boxes, menus, scroll bars, and graphics. The number of interface elements included in the preset layout template may refer to the number of all interface elements included in the preset layout template, or may also be data of the interface elements arranged longitudinally in the preset layout template.

Specifically, according to the ratio of the length to width of the current screen and the standard ratio of length to width, it can be derived from the proportional relationship that in case that the horizontal length ratios of the current screen and the preset layout template are the same, the difference value of the longitudinal length ratios of the current screen and the preset layout template is determined. Or according to the resolution of the current screen or the standard resolution, in case that the number of horizontal pixels of the current screen and the preset layout template are the same, the difference value of the number of longitudinal pixels of the current screen and the preset layout template is determined. And according to the number of interface elements included in the preset layout template, the number of longitudinal intervals between the interface elements in the preset layout template is determined, so that according to the difference value of the longitudinal length ratios or the difference value of the number of longitudinal pixels, and the number of longitudinal intervals, based on the preset layout template, the page layout of the page to be displayed is adjusted, to stretch or compress the longitudinal intervals between the interface elements of the preset layout template, wherein the size of the each interface element and the displayed contents thereof can also be adjusted, so as to realize displaying of the current screen being filled up with the page to be displayed or complete displaying of the page to be displayed on the current screen.

One example will be exemplified in the following:

FIG. 2 is an example diagram of page layout adjustment. Assuming that when the application was developed, the page layout was designed for the screens of the current mainstream mobile phone, that is, the preset layout template was adapted and designed based on the screen aspect ratio of the mobile phone of 16:9 or the screen resolution of 1080×1920, as shown in the left of FIG. 2. If the ratio of length to width of the current screen is 19:9 or the resolution of the current screen is 1080×2280, as compared to the screen to which the preset layout template is adapted, the current screen has the same horizontal length or the same number of horizontal pixels while the longitudinal length of the current screen is longer than the longitudinal length of the screen to which the preset layout template is adapted, that is, the mobile phone which is integrated with the current screen can be referred to as a long-screen mobile phone. And then when the long-screen mobile phone is about to display the page to be displayed, if displaying is performed directly according to the preset layout template, the display page is as shown in the middle of FIG. 2, in which lots of blanks appear in the lower part of the screen interface of the long-screen mobile phone. In turn, according to the present embodiment, a preset layout template associated with the page to be displayed is acquired, and through comparison of the ratio of length to width of the current screen with the standard ratio of length to width of the preset layout template (that is, the ratio of length to width of the current screen is 19:9, which is inconsistent with the standard ratio of 16:9) it is determined that normal displaying can be performed only after the page layout is adapted and adjusted.

Therefore, based on the situation that the horizontal lengths of the current screen and the preset layout template are the same, it is determined that the difference value between the longitudinal length of the current screen and the preset layout template is 3. Wherein as shown in FIG. 2, assuming that the number of longitudinal interface elements in the preset layout template is 5, then it is determined that the number of the longitudinal intervals included in the preset layout template is 4. Then the difference value of the longitudinal length ratio is averaged and arranged in the interval distances of the longitudinal intervals, that is, the length of [(1/19)*(3/4)] of the longitudinal length of the long-screen mobile phone is arranged in the interval distances of the longitudinal intervals, respectively. Or based on the situation that the numbers of horizontal pixels of the current screen and the preset layout template are the same, it is determined that the difference value between the numbers of longitudinal pixels of the current screen and the preset layout template is 360. Then, the difference value of the numbers of longitudinal pixels is averaged and arranged in the interval distances of the longitudinal intervals, that is, 90 rows of pixels are respectively arranged in the interval distance of the each longitudinal interval. The final displaying based on the adjusted page layout is as shown in the right of FIG. 2, in which the distances the intervals between the interface elements in the long-screen mobile phone are stretched, so that the page to be displayed is displayed with being filled up in the long-screen mobile phone.

It is worth noting that the above examples are merely illustrative of the implementation effects of the present solution, and do not limit the specific implementation manners of the solution, and the specific implementation manners are not limited to this.

In addition, in the present embodiment, also a display level may be set for the each interface element in advance according to evaluation factors such as importance and degree of attracting users of the displayed content of the each interface element and the like. Therefore, when the page layout is adjusted, a weight is set for at least one of longitudinal intervals adjacent to the interface elements according to the display level of the each interface element, and the interval distances of the longitudinal intervals between the interface elements in the initial page layout template will be adjusted based on the difference value of the longitudinal length ratios or the difference value of the numbers of the longitudinal pixels, and the number of the longitudinal intervals and the weight of the each longitudinal interval. In the present embodiment, also at least one of a lower distance threshold and an upper distance threshold for the longitudinal intervals may be set in advance, and after the longitudinal intervals are adjusted. if there are an interval distance of a longitudinal interval which exceed the lower distance threshold or the upper distance threshold, the longitudinal sizes of the corresponding interface elements can be adjusted and the displayed contents therein can be adjusted adaptively.

In the present embodiment, in case that it is detected that the ratio of the length to width of the current screen is consistent with the standard ratio of length to width, then a full-screen scaling ratio between the resolution of the current screen and the standard resolution can be determined; and scaling processing is performed on the preset layout template based on the full-screen scaling ratio to determine a current page layout template to adapt to the current screen for display.

In the screen adaptation and displaying method provided according to the present disclosure, before page displaying is performed, a preset page layout template of the page to be displayed can be acquired, and by comparing a ratio of the length to width of a current screen with a standard ratio of length to width associated with and adapted to the preset layout template, when it is determined to be inconsistent, the page layout of the page to be displayed will be adjusted based on the ratio of length to width of the current screen, the standard ratio of length to width associated with and adapted to the preset layout template and the number of interface elements included in the preset layout template, so as to adapt to the current screen for display. By using the screen adaptation and displaying method of the present embodiment, adaptation and displaying of the page to be displayed on the current screen can be realized through the adjustment of the page layout in case that the page layout template is not adapted to the current screen, which avoids that lots of blanks and being not able to completely display appear in the page, so that effectiveness of page information display, aesthetics of page display, and user experiences of users to which smart devices with different screen specifications belong are improved.

### Embodiment 2

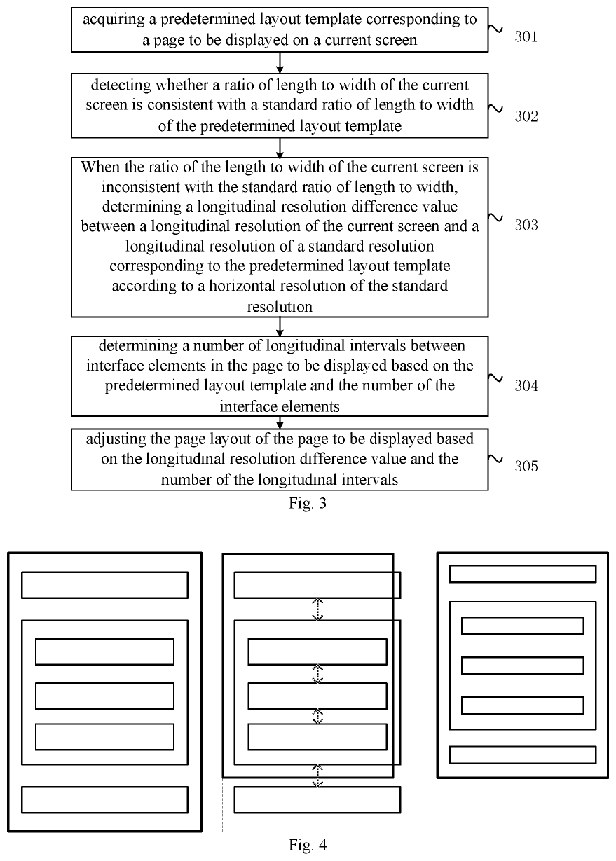

FIG. 3 shows a flowchart of a screen adaptation and displaying method provided by Embodiment 2 of the present disclosure. The present embodiment is applied to a scenario for adjusting a page layout to adapt to a screen display. Wherein the adjusting the page layout of the page to be displayed based on the ratio of length to width of the current screen, the standard ratio of length to width and the number of the interface elements included in the preset layout template includes: determining a longitudinal resolution difference value between a longitudinal resolution of the current screen and a longitudinal resolution of a standard resolution corresponding to the preset layout template according to a horizontal resolution of the standard resolution; determining a number of longitudinal intervals between interface elements in the page to be displayed based on the preset layout template and the number of the interface elements; and adjusting the page layout of the page to be displayed based on the longitudinal resolution difference value and the number of the longitudinal intervals. As shown in FIG. 3, the method includes the following steps.

Step S301, acquiring a predetermined layout template corresponding to a page to be displayed on a current screen

Step S302, detecting whether a ratio of length to width of the current screen is consistent with a standard ratio of length to width of the predetermined layout template

Step S303, when the ratio of the length to width of the current screen is inconsistent with the standard ratio of length to width, determining a longitudinal resolution difference value between a longitudinal resolution of the current screen and a longitudinal resolution of a standard resolution corresponding to the predetermined layout template according to a horizontal resolution of the standard resolution

In an embodiment of the present disclosure, based on the standard resolution corresponding to the preset layout template, regardless of any difference in the screen resolution of the current screen in the longitudinal or horizontal direction, through changes in ratio, in case that the horizontal resolution of the current screen is preferentially adjusted to be consistent with the horizontal resolution of the standard resolution corresponding to the preset layout template, the difference value between the longitudinal resolution of the current screen and the longitudinal resolution of the standard resolution is determined, so that the adjustment of the page layout is attributed to adjustment of the interval distances of the longitudinal intervals between the interface elements in the preset layout template

Alternatively, a horizontal scaling ratio between the horizontal resolution of the current screen and the horizontal resolution of the standard resolution may be determined based on the resolution of the current screen and the standard resolution; the longitudinal resolution of the current screen after scaling may be determined in dependence on the horizontal scaling ratio; and the longitudinal resolution difference value may be determined in dependence on the longitudinal resolution of the current screen after scaling and the longitudinal resolution of the standard resolution.

Specifically, the horizontal scaling ratio refers to the scaling ratio between the horizontal resolution of the current screen and the horizontal resolution of the standard resolution. In the present embodiment, the screen is not adjusted, but derivation and calculation is performed based on the resolution value. Wherein based on the horizontal scaling ratio, the horizontal resolution of the current screen after scaling is held consistent with the horizontal resolution of the standard resolution, and in turn in case that the horizontal resolutions are the same, the longitudinal resolution after the longitudinal resolution of the current screen is scaled based on the horizontal scaling ratio is determined, and the longitudinal resolution difference value between the scaled longitudinal resolution and the longitudinal resolution of the standard resolution is determined.

Explanation will be performed still by exemplifying the above example in the following:

The preset layout template is adapted and designed based on the screen resolution of the mobile phone of 1080×1920, that is, the standard resolution; and the resolution of the current screen is 1080×2280. Then it can be determined that the horizontal scaling ratio between the horizontal resolution 1080 of the current screen and the horizontal resolution 1080 of the standard resolution is 1. Correspondingly, based on the horizontal scaling ratio, it is determined that the longitudinal resolution of the current screen after scaling is 2280. Furthermore, it is determined that the longitudinal resolution difference value between the scaled longitudinal resolution and the longitudinal resolution of the standard resolution is 360. Based on the process of the above-mentioned derivation and calculation, it can be applied to adjustment of any screen parameter, such as screen display of an old type of mobile phones or screen display of a new type of mobile phones.

Step S304, determining a number of longitudinal intervals between interface elements in the page to be displayed based on the predetermined layout template and the number of the interface elements

In an embodiment of the present disclosure, the number of interface elements may refer to the number of all interface elements included in the preset layout template, or may be the data of the interface elements arranged longitudinally in the preset layout template. There is an interval between two adjacent interface elements, and therefore the number of longitudinal intervals between the interface elements in the page to be displayed can be determined according to the number of interface elements. Wherein the interface elements in the preset layout template may be arranged in one longitudinal column, or may be arranged in at least two longitudinal columns, or may be arranged alternately and longitudinally. Correspondingly, the number of intervals at different longitudinal positions may be different, and therefore the number of intervals at each longitudinal position can be determined according to the preset layout template and the number of interface elements, so as to facilitate subsequent adjustments to all longitudinal intervals.

Step S305, adjusting the page layout of the page to be displayed based on the longitudinal resolution difference value and the number of the longitudinal intervals

In an embodiment of the present disclosure, according to the longitudinal resolution difference value and the number of the longitudinal intervals, the page layout of the page to be displayed is adjusted based on the preset layout template, to stretch or compress the longitudinal intervals between the interface elements of the preset layout template, wherein the size of the each interface element and the displayed contents thereof can also be adjusted, so as to realize displaying of the current screen being filled up with the page to be displayed or complete displaying of the page to be displayed in the current screen.

Alternatively, scaling processing may be performed on the preset layout template in accordance with the horizontal scaling ratio to determine an initial page layout template and to adapt to horizontal displaying of the current screen; and interval distances of longitudinal intervals between the interface elements in the initial page layout template may be adjusted based on the longitudinal resolution difference value and the number of the longitudinal intervals to determine a current page layout template, so as to adapt to longitudinal display of the current screen.

In the present embodiment, the preset layout template itself is adjusted based on derivation of the parameters, that is, under the premise of ensuring the horizontal adaptation and adjustment of the page layout, the longitudinal adaptation and adjustment of the page layout is performed. Therefore, first, the page layout template is scaled and adjusted as a whole according to the horizontal scaling ratio to obtain the initial page layout template, so that the respective interface elements are adapted to display of the current screen in the horizontal direction. Correspondingly, there may be blanks or incomplete display in the longitudinal direction of the current screen. In turn, based on the longitudinal resolution difference value and the number of the longitudinal intervals, the interval distances needed to be adjusted for the longitudinal intervals between the interface elements are determined, so as to obtain the current page layout template, which is also adapted to the current screen in the longitudinal direction, so that all the interface elements in the preset layout template are filled up and displayed in the current screen.

Specifically, adjusting the page layout of the page to be displayed based on the longitudinal resolution difference value and the number of the longitudinal intervals may be implemented through a variety of methods. In the present embodiment, two more typical methods will be described here: Method 1 of averaging and arranging the longitudinal resolution difference value into the longitudinal intervals between the interface elements, and Method 2 of weighting and arranging the longitudinal resolution difference value into the longitudinal intervals between the interface elements based on the predetermined displaying level of the each interface element.

In the Method 1, an average adjustment distance is determined based on the longitudinal resolution difference value and the number of the longitudinal intervals; the interval distances of the longitudinal intervals between the interface elements is adjusted and extended by the average adjustment distance based on the longitudinal resolution difference value when the longitudinal resolution of the current screen after scaling is greater than the longitudinal resolution of the standard resolution, so as to determine the current page layout template; or the interval distances of the longitudinal intervals between the interface elements is adjusted and reduced by the average adjustment distance when the longitudinal resolution of the current screen after scaling is smaller than the longitudinal resolution of the standard resolution, so as to determine the current page layout template.

Wherein the difference between the longitudinal resolution of the current screen after scaling and the longitudinal resolution of the standard resolution can be determined in advance, so as to determine the relationship of the sizes of the longitudinal resolution of the current screen after scaling and the longitudinal resolution of the standard resolution according to the positive or negative of the difference of the longitudinal resolutions. If the longitudinal resolution of the current screen after scaling is greater than the longitudinal resolution of the standard resolution, stretching processing will be performed on the longitudinal intervals between the interface elements in the initial page layout template, that is, the interval distance of each longitudinal interval will be extended by the average adjustment distance, such as the above long-screen mobile phone in the example of FIG. 2. Conversely, if the longitudinal resolution of the current screen after scaling is smaller than the longitudinal resolution of the standard resolution, compressing processing will be performed on the longitudinal intervals between the interface elements in the initial page layout template, that is, the interval distance of each longitudinal interval will be reduced by the average adjustment distance. As shown in FIG. 4, the left of FIG. 4 is the page layout of the preset layout template adapted and designed based on the screen aspect ratio of the mainstream mobile phones. Assuming that the middle of FIG. 4 is direct displaying of an old type of the mobile phone according to the preset layout template, then the page to be displayed cannot be completely displayed according to the preset layout template. Therefore, after the horizontal adaptation and adjustment, that is, after the adjustment of the overall proportion of the preset layout module, the interval distances of the longitudinal intervals between the interface elements are adjusted and reduced by the average adjustment distance, as shown in FIG. 4 on the right.

In the Method 2, a weight of at least one longitudinal interval adjacent to each interface element is determined based on a predetermined displaying level associated with content of each interface element in the current page layout template; and the interval distances of the longitudinal intervals between the respective interface elements in the initial page layout template is adjusted based on the longitudinal resolution difference value, the number of the longitudinal intervals and the weight of each longitudinal interval to determine the current page layout template.

A displaying level may be set for each interface elements in advance according to evaluation factors such as importance and degree of attracting users of the displayed contents of the each interface element and the like. Therefore, when the page layout is adjusted, a weight is set for at least one longitudinal interval adjacent to the interface elements according to the displaying levels of the interface elements. And the adjustment distance of each longitudinal interval will be determined based on the longitudinal resolution difference value, the number of the longitudinal intervals and the weight of each longitudinal interval. Finally, also according to the relationship of the longitudinal resolution of the current screen after scaling and the longitudinal resolution of the standard resolution, the longitudinal intervals between the interface elements in the initial page layout template will be correspondingly adjusted respectively, to highlight the interface elements of the display level of more importance, to improve the display efficiency of the contents, to attract more users to browse, and to improve the user experience.

Exemplarily, the left of FIG. 5 is a page layout of a preset layout template adapted and designed based on the screen aspect ratio of the mainstream mobile phone, and the middle of FIG. 5 is a direct displaying effect according to the preset layout template. As shown in FIG. 5, the page layout template includes 5 interface elements. Assuming that the first interface element has the highest degree of user attraction, then the display level of the first interface element is predetermined to be level one. Assuming that the display contents of the second to fourth interface elements has the highest importance, the display levels of the second to fourth interface elements are predetermined to be level two, and correspondingly, the display level of the fifth interface element is level three. Among them, the first level is the highest level, and the third level is the lowest level. Therefore, according to the predetermined display level associated with the display contents of each interface element, the weight of the longitudinal interval adjacent to the first interface element can be set to a greater value, and the weight of the longitudinal intervals between the second to fourth interface elements can be set to a middle value, and the weight of the longitudinal interval adjacent to the fifth interface element is set to the minimum value. In turn, the first interface element, displaying of which can attract the user, is highlighted, the second to fourth interface elements with the displayed contents of more importance are secondly highlighted, and the fifth interface element is displayed normally, as shown in the right of FIG. 5.

Wherein in the present embodiment, also at least one of a lower distance threshold and an upper distance threshold for the longitudinal intervals may be set in advance, and after the longitudinal intervals are adjusted, if there are interval distances of the longitudinal intervals, which exceed the lower distance threshold or the upper distance threshold, the longitudinal sizes of the corresponding interface elements can be adjusted and the displayed contents therein can be adjusted adaptively.

Alternatively, the longitudinal size of the each interface elements in the current page layout template will be compressed and the displayed contents in the respective interface elements will be reduced if the interval distance of a longitudinal intervals is smaller than a preset lower distance threshold, so that the interval distances of the longitudinal intervals are not less than the preset lower distance threshold.

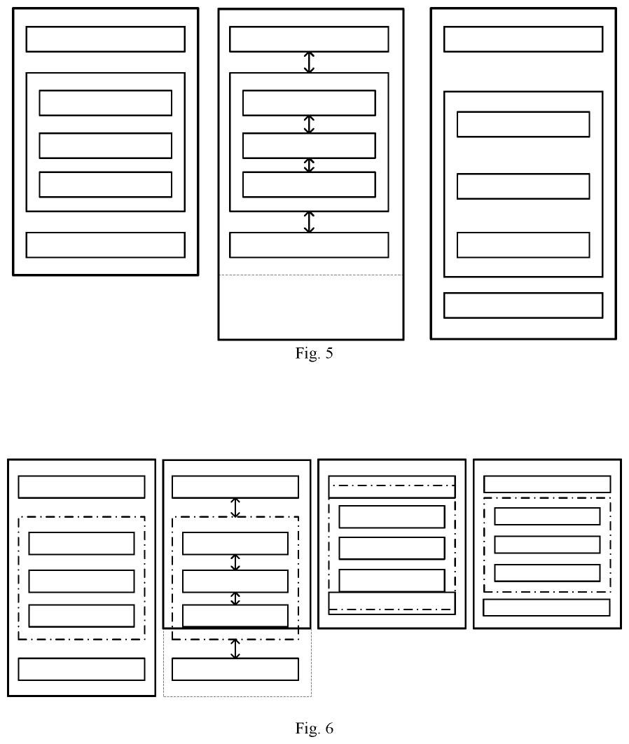

Specifically, the preset lower distance threshold refers to the minimum interval distance of the longitudinal intervals between the respective interface elements. When the interval distance of the longitudinal intervals is less than the preset lower distance threshold, there may be overlap between different interface elements, as shown in the third figure to the left of FIG. 6. Therefore, if the vertical distance of a vertical interval is smaller than the preset lower distance threshold, the longitudinal size of the each interface elements in the current page layout template is compressed, and the displayed contents in each interface element is reduced, so that the interval distance of each vertical interval is not less than the preset lower distance threshold, as shown in the fourth figure to the left of FIG. 6. Wherein the interval distance of the each longitudinal interval can be adjusted to be the size of the distance of the preset lower distance threshold, or can be adjusted to be between the preset lower distance threshold and the preset upper distance threshold.

Alternatively, the longitudinal size of each interface element in the current page layout template will be enlarged if the interval distance of each longitudinal interval is greater than a preset upper distance threshold, so that the interval distance of each longitudinal interval is not greater than the preset upper distance threshold.

Specifically, the preset upper distance threshold refers to the maximum interval distance of the longitudinal intervals between the respective interface elements. When the interval distance of a longitudinal interval is greater than the preset upper distance threshold, there may be lots of blanks in the longitudinal intervals between the interface elements, which affects the overall appearance of the page and the efficiency of displaying contents. Therefore, if the vertical distance between the vertical intervals is greater than the preset upper distance threshold, the longitudinal sizes of the interface elements in the current page layout template are enlarged, so that the interval distance of each vertical interval is not greater than the preset upper distance threshold. Wherein the interval distance of each longitudinal interval can be adjusted to be the size of the distance of the preset upper distance threshold, or can be adjusted to be between the preset lower distance threshold and the preset upper distance threshold.

Correspondingly, after the longitudinal size of the interface elements is enlarged and adjusted, the displayed contents in the interface elements can be appropriately increased.

Alternatively, potential content associated with each interface element may be determined based on the enlarged longitudinal size of each interface element in the current page layout template and the content in each interface element in the current page layout template; and the potential content may be added and displayed in the associated interface elements.

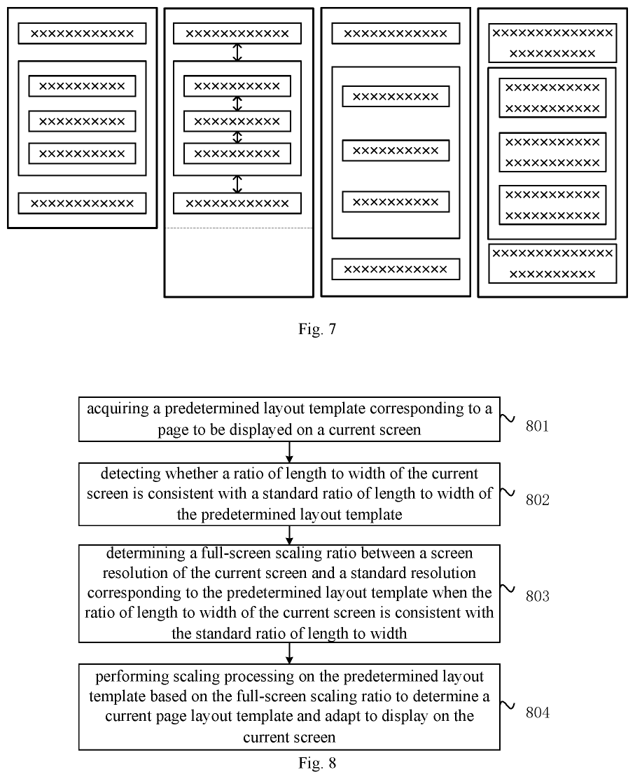

Specifically, the content of the each interface element may be displayed content in various forms such as text, icons, or pictures. Wherein for content that cannot be completely displayed due to the limitation of the displaying area, such as text, etc., the potential content associated with the interface elements can be determined according to the enlarged longitudinal size of the interface elements, so as to add and display the potential content in the associated interface element to improve the display efficiency of the content, as shown in FIG. 7. In the screen adaptation and displaying method according to the present disclosure, before page displaying is performed, a preset page layout template of the page to be displayed is acquired, when determining a ratio of length to width of a current screen is inconsistent with a standard ratio of length to width associated with and adapted to the preset layout template, based on the situation where the horizontal resolution of the current screen is consistent with the horizontal resolution of the standard resolution, according to the longitudinal resolution difference value between the longitudinal resolution of the current screen and the longitudinal resolution of the standard resolution, and the number of the longitudinal intervals between the interface elements in the preset layout template, the interval distances of longitudinal intervals between the interface elements in the page is adjusted, to adapt to the current screen for display. Wherein each longitudinal intervals can be averaged and arranged according to the longitudinal resolution difference value, or the respective longitudinal intervals may also be weighted and arranged according to the preset display level of each interface element. And the longitudinal size of each interface element after the layout adjustment and the display content thereof may also be adjusted. By using the screen adaptation and displaying method of the present embodiment, adaptation and displaying of the page to be displayed on the current screen can be realized through the adjustment of the page layout in case that the page layout template is not adapted to the current screen, which avoids that lots of blanks and being not able to completely display appear in the page, so that effectiveness of page information displaying, aesthetics of page displaying, and user experiences of users to which smart devices with different screen specifications belong are improved.

### Embodiment 3

FIG. 8 shows a flowchart of a screen adaptation and displaying method provided by Embodiment 3 of the present disclosure. The present embodiment is applied to a scenario for adjusting a page layout to adapt to a screen display. As shown in FIG. 8, the method includes the following steps:

Step S801, acquiring a predetermined layout template corresponding to a page to be displayed on a current screen

Step S802, detecting whether a ratio of length to width of the current screen is consistent with a standard ratio of length to width of the predetermined layout template

Step S803 determining a full-screen scaling ratio between a screen resolution of the current screen and a standard resolution corresponding to the predetermined layout template when the ratio of length to width of the current screen is consistent with the standard ratio of length to width

In an embodiment of the present disclosure, since the ratio of length to width of the current screen is consistent with the standard ratio of length to width, then after the preset layout template is scaled as a whole, it can be adapted to the current screen for displaying. Therefore, ratio between the screen resolution of the current screen and a standard resolution corresponding to the predetermined layout template is determined as the full-screen scaling ratio.

Step S804, performing scaling processing on the predetermined layout template based on the full-screen scaling ratio to determine a current page layout template and adapt to display on the current screen

In an embodiment of the present disclosure, the entire preset layout template is scaled according to the full-screen scaling ratio to obtain the current page layout template, which is displayed in the current screen. Wherein when the resolution of the current screen is the same as the standard resolution, the full-screen scaling ratio can be regarded as 1, and displaying can be performed directly according to the preset layout template.

In the screen adaptation and displaying method provided according to the present disclosure, before page displaying is performed, a preset page layout template of the page to be displayed is acquired, and when determining the ratio of the length to width of a current screen is consistent with a standard ratio of length to width associated with and adapted to the preset layout template, the direct ratio between the resolution of the current screen and the standard resolution can be determined as the full-screen scaling ratio and the entire preset layout template can be scaled according to the full-screen scaling ratio. By using the screen adaptation and displaying method of the present embodiment, adaptation and displaying of the page to be displayed on the current screen can be realized through the adjustment of the page layout in case that the page layout template is not adapted to the current screen, which avoids that lots of blanks and being not able to completely display appear in the page, so that effectiveness of page information display, aesthetics of page display, and user experiences of users to which smart devices with different screen specifications belong are improved.

### Embodiment 4

The Embodiment 4 of the present disclosure also provides a non-volatile computer-readable storage medium in which at least one executable instruction is stored, wherein the executable instruction is configured to cause the computer to execute a screen adaptation and displaying method in any of the above method embodiments.

The executable instruction may be configured to cause a processor to perform the following operations:

acquiring a predetermined layout template corresponding to a page to be displayed on a current screen;

detecting whether a ratio of length to width of the current screen is consistent with a standard ratio of length to width of the predetermined layout template; and

when the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

In an alternative embodiment, the executable instruction may further cause the processor to perform the following operations:

determining a longitudinal resolution difference value between a longitudinal resolution of the current screen and a longitudinal resolution of a standard resolution corresponding to the predetermined layout template according to a horizontal resolution of the standard resolution;

determining a number of longitudinal intervals between interface elements in the page to be displayed based on the predetermined layout template and the number of the interface elements; and

adjusting the page layout of the page to be displayed based on the longitudinal resolution difference value and the number of the longitudinal intervals.

In an alternative embodiment, the executable instruction may further cause the processor to perform the following operations:

determining a horizontal scaling ratio between a horizontal resolution of the current screen and the horizontal resolution of the standard resolution based on a screen resolution of the current screen and the standard resolution;

determining the longitudinal resolution of the current screen after scaling based on the horizontal scaling ratio; and

determining the longitudinal resolution difference value based on the longitudinal resolution of the current screen after scaling and the longitudinal resolution of the standard resolution.

In an alternative embodiment, the executable instruction may further cause the processor to perform the following operations:

performing scaling processing on the predetermined layout template based on the horizontal scaling ratio to determine an initial page layout template and adapt for horizontal displaying on the current screen; and

adjusting interval distances of longitudinal intervals between interface elements in the initial page layout template based on the longitudinal resolution difference value and the number of the longitudinal intervals to determine a current page layout template and adapt for longitudinal displaying on the current screen.

In an alternative embodiment, the executable instruction may further cause the processor to perform the following operations:

determining an average adjustment distance based on the longitudinal resolution difference value and the number of the longitudinal intervals; and

extending the interval distances of the longitudinal intervals between the interface elements by the average adjustment distance based on the longitudinal resolution difference value when the longitudinal resolution of the current screen after scaling is greater than the longitudinal resolution of the standard resolution, so as to determine the current page layout template; or, reducing the interval distances of the longitudinal intervals between the interface elements by the average adjustment distance when the longitudinal resolution of the current screen after scaling is smaller than the longitudinal resolution of the standard resolution, so as to determine the current page layout template.

In an alternative embodiment, the executable instruction may further cause the processor to perform the following operations:

determining a weight of at least one longitudinal interval adjacent to each interface element based on a predetermined displaying level corresponding to content of each interface element in the current page layout template; and

adjusting the interval distances of the longitudinal intervals between the interface elements in the initial page layout template based on the longitudinal resolution difference value, the number of the longitudinal intervals, and the weight of each longitudinal interval to determine the current page layout template.

In an alternative embodiment, the executable instruction may further cause the processor to perform the following operations:

compressing a longitudinal size of each interface element in the current page layout template and reducing content in each interface element when the interval distances of the longitudinal intervals are smaller than a predetermined lower distance threshold, so that the interval distances of the longitudinal intervals are not smaller than the predetermined lower distance threshold; or

enlarging a longitudinal size of each interface element in the current page layout template when the interval distances of the longitudinal intervals are greater than a predetermined upper distance threshold, so that the interval distances of the longitudinal intervals are not greater than the predetermined upper distance threshold.

In an alternative embodiment, the executable instruction may further cause the processor to perform the following operations:

determining potential content associated with each interface element based on the enlarged longitudinal size of each interface element in the current page layout template and the content in each interface element in the current page layout template; and

adding and displaying the potential content in the associated interface element.

In an alternative embodiment, the executable instruction may further cause the processor to perform the following operations:

determining a full-screen scaling ratio between a screen resolution of the current screen and a standard resolution corresponding to the predetermined layout template when the ratio of length to width of the current screen is consistent with the standard ratio of length to width; and

performing scaling processing on the predetermined layout template based on the full-screen scaling ratio to determine a current page layout template and adapt to display on the current screen.

### Embodiment 5

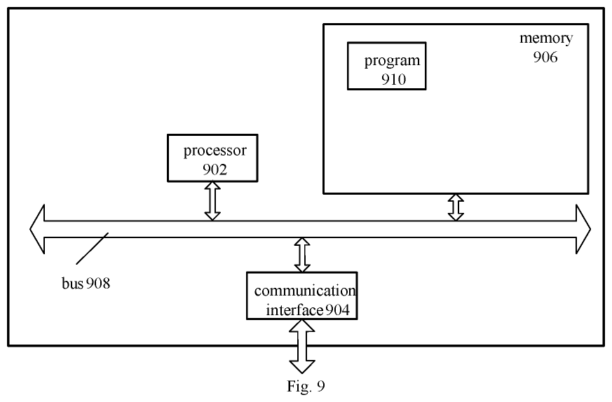

FIG. 9 shows a schematic structural diagram of an electronic device according to the Embodiment 5 of the present disclosure, and the specific embodiment of the present disclosure does not limit the specific implementation of the electronic device.

As shown in FIG. 9, the electronic device may include: a processor 902, a communication interface 904, a memory 906, and a communication bus 908.

Wherein:

The processor 902, the communication interface 904, and the memory 906 communicate with each other through the communication bus 908.

The communication interface 904 is configured to communicate with other devices such as network elements such as clients or other servers.

The processor 902 is configured to execute a program 910, and specifically can execute the relevant steps in the embodiments of the above-described screen adaptation and displaying method.

Specifically, the program 910 may include a program code, which includes computer operation instruction.

The processor 902 may be a central processing unit CPU, or an Application Specific Integrated Circuit (ASIC), or one or more integrated circuits configured to implement the embodiments of the present disclosure. One or more processors included in the electronic device may be the same type of processor, such as one or more CPUs, or different types of processors, such as one or more CPUs and one or more ASICs.

The memory 906 is configured to store the program 910. The memory 906 may include a high-speed RAM memory, and may also include a non-volatile memory, such as at least one magnetic disk memory.

The program 910 may be specifically configured to cause the processor 902 to perform the following operations:

acquiring a predetermined layout template corresponding to a page to be displayed on a current screen;

detecting whether a ratio of length to width of the current screen is consistent with a standard ratio of length to width of the predetermined layout template; and

when the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

In an alternative embodiment, the program 910 may be specifically further configured to cause the processor 902 to perform the following operations:

determining a longitudinal resolution difference value between a longitudinal resolution of the current screen and a longitudinal resolution of a standard resolution corresponding to the predetermined layout template according to a horizontal resolution of the standard resolution;

determining a number of longitudinal intervals between interface elements in the page to be displayed based on the predetermined layout template and the number of the interface elements; and

adjusting the page layout of the page to be displayed based on the longitudinal resolution difference value and the number of the longitudinal intervals.

In an alternative embodiment, the program 910 may be specifically further configured to cause the processor 902 to perform the following operations:

determining a horizontal scaling ratio between a horizontal resolution of the current screen and the horizontal resolution of the standard resolution based on a screen resolution of the current screen and the standard resolution;

determining the longitudinal resolution of the current screen after scaling based on the horizontal scaling ratio; and

determining the longitudinal resolution difference value based on the longitudinal resolution of the current screen after scaling and the longitudinal resolution of the standard resolution.

In an alternative embodiment, the program 910 may be specifically further configured to cause the processor 902 to perform the following operations:

performing scaling processing on the predetermined layout template based on the horizontal scaling ratio to determine an initial page layout template and adapt for horizontal displaying on the current screen; and

adjusting interval distances of longitudinal intervals between interface elements in the initial page layout template based on the longitudinal resolution difference value and the number of the longitudinal intervals to determine a current page layout template and adapt for longitudinal displaying on the current screen.

In an alternative embodiment, the program 910 may be specifically further configured to cause the processor 902 to perform the following operations:

determining an average adjustment distance based on the longitudinal resolution difference value and the number of the longitudinal intervals; and

extending the interval distances of the longitudinal intervals between the interface elements by the average adjustment distance based on the longitudinal resolution difference value when the longitudinal resolution of the current screen after scaling is greater than the longitudinal resolution of the standard resolution, so as to determine the current page layout template; or, reducing the interval distances of the longitudinal intervals between the interface elements by the average adjustment distance when the longitudinal resolution of the current screen after scaling is smaller than the longitudinal resolution of the standard resolution, so as to determine the current page layout template.

In an alternative embodiment, the program 910 may be specifically further configured to cause the processor 902 to perform the following operations:

determining a weight of at least one longitudinal interval adjacent to each interface element based on a predetermined displaying level corresponding to content of each interface element in the current page layout template; and

adjusting the interval distances of the longitudinal intervals between the interface elements in the initial page layout template based on the longitudinal resolution difference value, the number of the longitudinal intervals, and the weight of each longitudinal interval to determine the current page layout template.

In an alternative embodiment, the program 910 may be specifically further configured to cause the processor 902 to perform the following operations:

compressing a longitudinal size of each interface element in the current page layout template and reducing content in each interface element when the interval distances of the longitudinal intervals are smaller than a predetermined lower distance threshold, so that the interval distances of the longitudinal intervals are not smaller than the predetermined lower distance threshold; or

enlarging a longitudinal size of each interface element in the current page layout template when the interval distances of the longitudinal intervals are greater than a predetermined upper distance threshold, so that the interval distances of the longitudinal intervals are not greater than the predetermined upper distance threshold.

In an alternative embodiment, the program 910 may be specifically further configured to cause the processor 902 to perform the following operations:

determining potential content associated with each interface element based on the enlarged longitudinal size of each interface element in the current page layout template and the content in each interface element in the current page layout template; and

adding and displaying the potential content in the associated interface element.

In an alternative embodiment, the program 910 may be specifically further configured to cause the processor 902 to perform the following operations:

determining a full-screen scaling ratio between a screen resolution of the current screen and a standard resolution corresponding to the predetermined layout template when the ratio of length to width of the current screen is consistent with the standard ratio of length to width; and

performing scaling processing on the predetermined layout template based on the full-screen scaling ratio to determine a current page layout template and adapt to display on the current screen.

The algorithms and displays provided here are not inherently related to any particular computer, virtual system or other equipment. Various general-purpose systems can also be used with the teaching based on this. Based on the above description, the structure required to construct this type of system is obvious. In addition, the embodiments of the present disclosure are not directed to any specific programming language. It should be understood that various programming languages may be used to implement the content of the embodiments of the present disclosure described herein, and the above description of specific languages is for the purpose of disclosing the best implementation of the embodiments of the present disclosure.

In the instructions provided here, a lot of specific details are explained. However, it can be understood that the embodiments of the present disclosure may be practiced without these specific details. In some instances, well-known methods, structures, and technologies are not shown in detail, so as not to obscure the understanding of this specification.

Similarly, it should be understood that in order to streamline the present disclosure and help understand one or more of the various disclosed aspects, in the above description of the exemplary embodiments of the present disclosure, the various features of the embodiments of the present disclosure are sometimes grouped together into a single implementation. Examples, diagrams, or descriptions. However, the disclosed method should not be interpreted as reflecting the intention that the claimed disclosure requires more features than those explicitly recorded in each claim. More precisely, as reflected in the following claims, the disclosure aspect lies in less than all the features of a single embodiment previously disclosed. Therefore, the claims following the specific embodiment are thus explicitly incorporated into the specific embodiment, wherein each claim itself serves as a separate embodiment of the present disclosure.

Those skilled in the art can understand that it is possible to adaptively change the modules in the device in the embodiment and set them in one or more devices different from the embodiment. The modules or units or components in the embodiments can be combined into one module or unit or component, and in addition, they can be divided into multiple sub-modules or sub-units or sub-components. Except that at least some of such features or processes or units are mutually exclusive, any combination can be used to compare all the features disclosed in this specification (including the accompanying claims, abstract and drawings) and any method or device thus disclosed. All processes or units are combined. Unless expressly stated otherwise, each feature disclosed in this specification (including the accompanying claims, abstract and drawings) may be replaced by an alternative feature providing the same, equivalent or similar purpose.

In addition, those skilled in the art can understand that although some embodiments described herein include certain features included in other embodiments but not other features, the combination of features of different embodiments means that they are within the scope of the present disclosure. Within and form different embodiments. For example, in the following claims, any one of the claimed embodiments can be used in any combination.

It should be noted that the above-mentioned embodiments illustrate rather than limit the present disclosure, and those skilled in the art can design alternative embodiments without departing from the scope of the appended claims. In the claims, any reference signs placed between parentheses should not be constructed as a limitation to the claims. The word “comprising” does not exclude the presence of elements or steps not listed in the claims. The word “a” or “an” preceding an element does not exclude the presence of multiple such elements. The embodiments of the present disclosure can be implemented by means of hardware including several different elements and by means of a suitably programmed computer. The use of the words first, second, and third, etc. do not indicate any order. These words can be interpreted as names.

1. A method for adjusting a page layout to adapt to display on a screen, comprising:
acquiring a predetermined layout template corresponding to a page to be displayed on a current screen;
determining whether a ratio of length to width of the current screen is consistent with a standard ratio of length to width of the predetermined layout template; and
in response to a determination that the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

2. The method according to claim 1, further comprising:
determining a longitudinal resolution difference value based on a longitudinal resolution of the current screen and a longitudinal resolution of a standard resolution corresponding to the predetermined layout template;
determining a number of longitudinal intervals between interface elements in the page to be displayed based on the predetermined layout template and the number of the interface elements in the predetermined layout template; and
adjusting the page layout of the page to be displayed based on the longitudinal resolution difference value and the number of the longitudinal intervals.

3. The method according to claim 2, further comprising:
determining a horizontal scaling ratio based on horizontal resolution of the current screen and a horizontal resolution of the standard resolution.

4. The method according to claim 3, further comprising:
performing scaling processing on the predetermined layout template based on the horizontal scaling ratio to determine an initial page layout template and adapt for horizontal displaying on the current screen; and
adjusting interval distances of longitudinal intervals between interface elements in the initial page layout template based on the longitudinal resolution difference value and the number of the longitudinal intervals to determine a current page layout template and adapt for longitudinal displaying on the current screen.

5. The method according to claim 4, wherein the adjusting interval distances of longitudinal intervals between interface elements in the initial page layout template based on the longitudinal resolution difference value and the number of the longitudinal intervals further comprises:
determining an average adjustment distance based on the longitudinal resolution difference value and the number of the longitudinal intervals; and
extending the interval distances of the longitudinal intervals between the interface elements by the average adjustment distance when the longitudinal resolution of the current screen is greater than the longitudinal resolution of the standard resolution; or, reducing the interval distances of the longitudinal intervals between the interface elements by the average adjustment distance when the longitudinal resolution of the current screen after scaling is smaller than the longitudinal resolution of the standard resolution.

6. The method according to claim 4, wherein the adjusting interval distances of longitudinal intervals between interface elements in the initial page layout template based on the longitudinal resolution difference value and the number of the longitudinal intervals further comprises:
determining a weight of at least one longitudinal interval adjacent to each interface element based on a predetermined displaying level corresponding to content of each interface element; and
adjusting the interval distances of the longitudinal intervals between the interface elements in the initial page layout template based on the longitudinal resolution difference value, the number of the longitudinal intervals, and the weight of each longitudinal interval.

7. The method according to claim 4, further comprising:
compressing a longitudinal size of each interface element in the current page layout template and reducing content in each interface element when the interval distances of the longitudinal intervals are smaller than a predetermined lower distance threshold, so that the interval distances of the longitudinal intervals are not smaller than the predetermined lower distance threshold; or
enlarging a longitudinal size of each interface element in the current page layout template when the interval distances of the longitudinal intervals are greater than a predetermined upper distance threshold, so that the interval distances of the longitudinal intervals are not greater than the predetermined upper distance threshold.

8. The method according to claim 7, wherein after the enlarging a longitudinal size of each interface element in the current page layout template, the method further comprises:
determining potential content associated with each interface element based on the enlarged longitudinal size of each interface element in the current page layout template and the content in each interface element in the current page layout template; and
adding and displaying the potential content in the associated interface element.

9. The method according to claim 1, further comprising:
determining a full-screen scaling ratio between a screen resolution of the current screen and a standard resolution corresponding to the predetermined layout template in response to determining that the ratio of length to width of the current screen is consistent with the standard ratio of length to width; and
performing scaling processing on the predetermined layout template based on the full-screen scaling ratio to determine a current page layout template and adapt to display on the current screen.

10. An electronic device, comprising: a processor, a memory, a communication interface and a communication bus, wherein the processor, the memory and the communication interface communicate with each other through the communication bus, wherein the memory is configured to store executable instructions that upon execution cause the processor to perform operations, the operations comprising:
acquiring a predetermined layout template corresponding to a page to be displayed on a current screen;
determining whether a ratio of length to width of the current screen is consistent with a standard ratio of length to width of the predetermined layout template; and
in response to a determination that the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

11. The electronic device according to claim 10, wherein the operations further comprise:
determining a longitudinal resolution difference value based on a longitudinal resolution of the current screen and a longitudinal resolution of a standard resolution corresponding to the predetermined layout template;
determining a number of longitudinal intervals between interface elements in the page to be displayed based on the predetermined layout template and the number of the interface elements in the predetermined layout template; and
adjusting the page layout of the page to be displayed based on the longitudinal resolution difference value and the number of the longitudinal intervals.

12. The electronic device according to claim 11, wherein the operations further comprise:
determining a horizontal scaling ratio based on a horizontal resolution of the current screen and a horizontal resolution of the standard resolution.

13. The electronic device according to claim 12, wherein the operations further comprise:
performing scaling processing on the predetermined layout template based on the horizontal scaling ratio to determine an initial page layout template and adapt for horizontal displaying on the current screen; and
adjusting interval distances of longitudinal intervals between interface elements in the initial page layout template based on the longitudinal resolution difference value and the number of the longitudinal intervals to determine a current page layout template and adapt for longitudinal displaying on the current screen.

14. The electronic device according to claim 13, wherein the operations further comprise:
determining an average adjustment distance based on the longitudinal resolution difference value and the number of the longitudinal intervals; and
extending the interval distances of the longitudinal intervals between the interface elements by the average adjustment distance when the longitudinal resolution of the current screen is greater than the longitudinal resolution of the standard resolution; or, reducing the interval distances of the longitudinal intervals between the interface elements by the average adjustment distance when the longitudinal resolution of the current screen after scaling is smaller than the longitudinal resolution of the standard resolution.

15. The electronic device according to claim 13, wherein the operations further comprise:
determining a weight of at least one longitudinal interval adjacent to each interface element based on a predetermined displaying level corresponding to content of each interface element; and
adjusting the interval distances of the longitudinal intervals between the interface elements in the initial page layout template based on the longitudinal resolution difference value, the number of the longitudinal intervals, and the weight of each longitudinal interval.

16. The electronic device according to claim 13, wherein the operations further comprise:
compressing a longitudinal size of each interface element in the current page layout template and reducing content in each interface element when the interval distances of the longitudinal intervals are smaller than a predetermined lower distance threshold, so that the interval distances of the longitudinal intervals are not smaller than the predetermined lower distance threshold; or
enlarging a longitudinal size of each interface element in the current page layout template when the interval distances of the longitudinal intervals are greater than a predetermined upper distance threshold, so that the interval distances of the longitudinal intervals are not greater than the predetermined upper distance threshold.

17. The electronic device according to claim 16, wherein the operations further comprise:
determining potential content associated with each interface element based on the enlarged longitudinal size of each interface element in the current page layout template and the content in each interface element in the current page layout template; and
adding and displaying the potential content in the associated interface element.

18. The electronic device according to claim 10, wherein the operations further comprise:
determining a full-screen scaling ratio between a screen resolution of the current screen and a standard resolution corresponding to the predetermined layout template in response to determining that the ratio of length to width of the current screen is consistent with the standard ratio of length to width; and
performing scaling processing on the predetermined layout template based on the full-screen scaling ratio to determine a current page layout template and adapt to display on the current screen.

19. A non-volatile computer readable storage medium, storing at least one executable instruction, wherein the executable instruction is configured to cause a processor to perform operations comprising:
acquiring a predetermined layout template corresponding to a page to be displayed on a current screen;
determining whether a ratio of length to width of the current screen is consistent with a standard ratio of length to width of the predetermined layout template; and
in response to a determination that the ratio of the length to width of the current screen is inconsistent with the standard ratio of length to width, adjusting a page layout of the page to be displayed based on the ratio of length to width of the current screen, the standard ratio of length to width, and a number of interface elements included in the predetermined layout template so as to adapt to display on the current screen.

20. (canceled)

21. The non-volatile computer readable storage medium of claim 19, the operations further comprising:
determining a horizontal scaling ratio based on a horizontal resolution of the current screen and a horizontal resolution of a standard resolution corresponding to the predetermined layout template;
performing scaling processing on the predetermined layout template based on the horizontal scaling ratio to determine an initial page layout template and adapt for horizontal displaying on the current screen; and
adjusting interval distances of longitudinal intervals between interface elements in the initial page layout template based at least in part on a longitudinal resolution difference value between a longitudinal resolution of the current screen and a longitudinal resolution of the standard resolution to determine a current page layout template and adapt for longitudinal displaying on the current screen.
